(19) United States
(12) Patent Application Publication
(10) Pub. No.: US 2015/0339739 A1
(43) Pub. Date: Nov. 26, 2015

(54) CORPORATE BILL SELLING SYSTEM WITH ANTI-COUNTERFEITING VERIFICATION

(71) Applicants: Jian BU, Chengdu, Sichuan (CN); An LUO, Chengdu, Sichuan (CN); Shaochuan FENG, Chengdu, Sichuan (CN); Huifang YANG, Chengdu, Sichuan (CN); Mingyuan LUO, Chengdu, Sichuan (CN); Xiaoling WANG, Chengdu, Sichuan (CN); Xiaobo LI, Chengdu, Sichuan (CN); Wanbin XIE, Chengdu, Sichuan (CN)

(72) Inventors: Jian BU, Chengdu, Sichuan (CN); An LUO, Chengdu, Sichuan (CN); Shaochuan FENG, Chengdu, Sichuan (CN); Huifang YANG, Chengdu, Sichuan (CN); Mingyuan LUO, Chengdu, Sichuan (CN); Xiaoling WANG, Chengdu, Sichuan (CN); Xiaobo LI, Chengdu, Sichuan (CN); Wanbin XIE, Chengdu, Sichuan (CN)

(73) Assignee: Chengdu SANTAI Holding Group Co., Ltd., Chengdu, Sichuan (CN)

(21) Appl. No.: 14/391,083

(22) PCT Filed: Aug. 22, 2012
(86) PCT No.: PCT/CN2012/080453

§ 371 Date: Oct. 7, 2014

(30) Foreign Application Priority Data
Apr. 26, 2012 (CN) 201210126459.7

(51) Int. Cl. G06Q 30/04; G06Q 20/18; G06Q 30/00

(52) U.S. Cl. CPC G06Q 30/04; G06Q 30/018; G06Q 20/18; G06Q 2220/00

(57) ABSTRACT

The invention relates to an automation technology. The invention solves existing problems of insufficient flexibility, convenience and low security in purchasing corporate bills, and provides a corporate bill selling system with anti-counterfeiting verification, the technical solution thereof can be summarized as follows: a corporate bill selling system with anti-counterfeiting verification comprises a corporate bill selling center platform and at least one front-end corporate bill self-service terminal, the corporate bill selling center platform is connected with the at least one front-end corporate bill self-service terminal; the corporate bill selling center platform is used for providing entry of system basic platform building information, data storage, equipment monitoring, optical character recognition (OCR), interface with an external system and system data inquiry statistics management; and the front-end corporate bill self-service terminal is used for storing corporate bills, achieving interaction with users, and acquiring and identifying key information of corporate bills.

### FIELD OF THE INVENTION

The invention relates to an automation technology, in particular to an automatic bank corporate bill processing technology.

### DESCRIPTION OF THE RELATED ART

In recent years, the People's Bank of China has gradually established and successfully promoted and run an imaging technology-based corporate bill image exchange system on a national scale. The system supports nationwide use of corporate bills. On such basis, the corporate bill business volume grows stably, and increase in the corporate bill business volume results in increased pressure on bank counters. How to use self-service equipment to reduce pressure on the counters becomes a concern of all commercial banks. At present, there are at least three problems in corporate bill selling business flow of bank enterprises: 1. the corporate bills of bank enterprises are generally sold to the customers in such a manner that customer accountants purchase the corporate bills at the bank counters regularly, lacking flexibility and convenience; 2. some banks use general office laser printers to print information such as names of paying banks and drawer accounts, some other banks print two-dimensional bar codes and magnetic codes for standardized management of bills, and if two-dimensional bar code and magnetic code need to be printed, a corporate bill needs to be printed for three times, thus two printers are needed or cartridges filled with different types of carbon powder shall be changed back and forth, resulting troublesome operation; and 3. the existing banks only register bill codes and names of purchasers in selling corporate bills, and security considerations for use of bills are insufficient to avoid use of clone bills. The corporate bills herein comprise checks, receipts and drafts.

### SUMMARY OF THE INVENTION

The technical problem to be solved by the invention is to solve existing defects of insufficient flexibility and convenience and low security in purchasing corporate bills, and provide a corporate bill selling system with anti-counterfeiting verification.

A technical solution for solving the technical problem in the invention is a corporate bill selling system with anti-counterfeiting verification, characterized by comprising a corporate bill selling center platform and at least one front-end corporate bill self-service terminal, and the corporate bill selling center platform being connected with the at least one front-end corporate bill self-service terminal;

the corporate bill selling center platform being used for providing entry of system basic platform building information, data storage, equipment monitoring, optical character recognition (OCR), interface with an external system and system data inquiry statistics management; and

the front-end corporate bill self-service terminal is used for storing corporate bills, achieving interaction with users, and acquiring and identifying key information of corporate bills.

In particular, the acquisition and identification of key information of corporate bills comprise corporate bill image acquisition, corporate bill authenticity identification and corporate bill element entry.

Further, the corporate bill selling center platform comprises a corporate bill selling management module, a corporate bill selling service module, a corporate bill selling identification encryption module, a corporate bill selling interface module and a database, the corporate bill selling management module is connected with the database, the corporate bill selling service module is connected with the database and the corporate bill selling interface module, and the corporate bill selling identification encryption module is connected to the corporate bill selling service module;

the corporate bill selling management module is used for management of basic information of the overall system, system parameter setting and the front-end corporate bill self-service terminal, as well as real-time monitoring of running status of the front-end corporate bill self-service terminal, and business acceptance statistics;

the corporate bill selling service module is used for realizing data interaction between the front-end corporate bill self-service terminal and the corporate bill selling center platform;

the corporate bill selling identification encryption module is used for realizing encrypted storage of key elements of corporate bills using OCR technology and an encryption algorithm;

the corporate bill selling interface module is used for connecting the front-end corporate bill self-service terminal; and

the database is used for storing all kinds of data information.

In particular, the key elements comprise two-dimensional codes and magnetic codes of corporate bills.

Further, the front-end corporate bill self-service terminal comprises a terminal host, a corporate bill storage box, a corporate bill clearing box, an authentication module, a front-end interface, a corporate bill information print module and a corporate bill information scanning module, the authentication module is connected with the terminal host, the corporate bill information print module is connected with the terminal host, the corporate bill information scanning module is connected with the terminal host, the corporate bill storage box is connected with the corporate bill clearing box, the corporate bill storage box and the corporate bill clearing box are connected with the terminal host respectively, and the terminal host is connected to a private banking network through the front-end interface, and then connected to the corporate bill selling interface module of the corporate bill selling center platform via the private network;

the terminal host is used for control of all modules connected thereto and interacts with the corporate bill selling center platform through the front-end interface;

the corporate bill storage box is used for storing corporate bills;

the corporate bill clearing box is used for providing corporate bills for users;

the customer authentication module is used for authentication of corporate bill buyers based on input of the corporate bill buyers;

the corporate bill information print module is used for printing required corporate bill face information; and

the corporate bill information scanning module is used for scanning front and back images and ultraviolet images (UV images) of corporate bills.

In particular, the corporate bill clearing box is also equipped with a security gate connected with the terminal host.

Further, the required corporate bill face information comprises text information, magnetic code information and two-dimensional code information.

In particular, a printing device used by the corporate bill information print module can simultaneously print text, magnetic code and two-dimensional code.

Further, the corporate bills comprise checks and/or receipts and/or drafts.

The beneficial effects of the invention are as follows: with the corporate bill selling system with anti-counterfeiting verification, users need not purchase corporate bills at the counter of any bank; certain recognition capability is realized due to the customer authentication module, and text, magnetic code and two-dimensional code can be simultaneously printed to strengthen the anti-counterfeiting ability, provide convenience for users and improve the work efficiency of banks.

### BRIEF DESCRIPTION OF THE DRAWINGS

FIG. 1 is a system block diagram of the embodiment.

### DESCRIPTION OF THE PREFERRED EMBODIMENTS

The technical solution of the invention will be described in detail in combination with accompanying drawing and embodiment.

The corporate bill selling system with anti-counterfeiting verification of the invention consists of a corporate bill selling center platform and at least one front-end corporate bill self-service terminal which are connected with each other. The corporate bill selling center platform is used for providing entry of system basic platform building information, data storage, equipment monitoring, optical character recognition (OCR), interface with an external system and system data inquiry statistics management; and the front-end corporate bill self-service terminal is used for storing corporate bills, achieving interaction with users, and acquiring and identifying key information of corporate bills so as to realize corporate bill selling automation and provide convenience for users.

### Embodiment

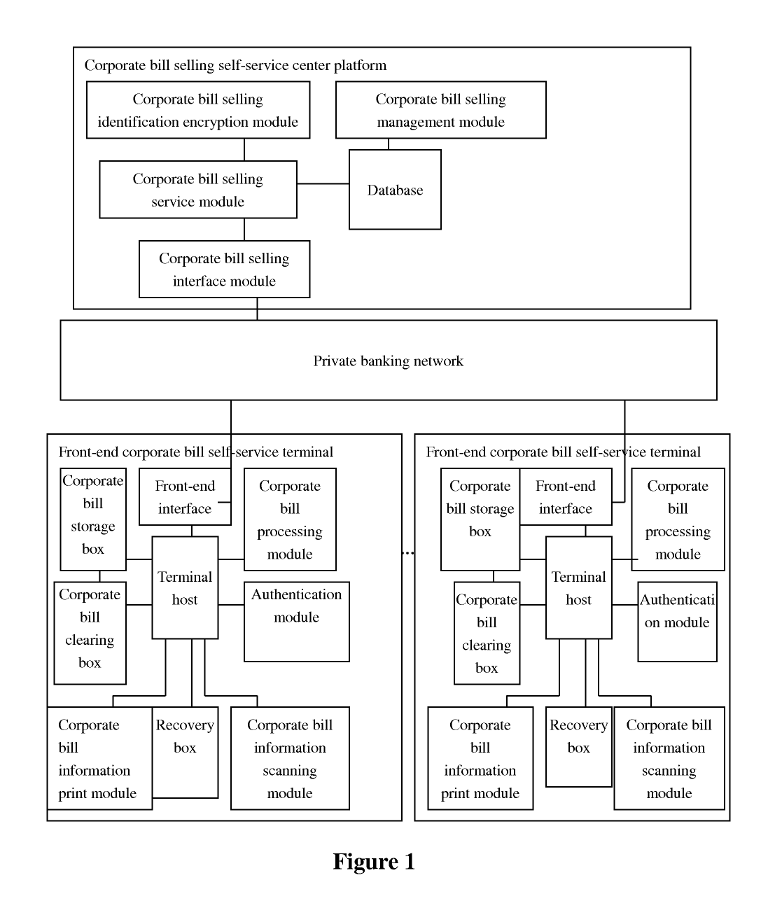

In the embodiment, the corporate bill selling center platform comprises a corporate bill selling management module, a corporate bill selling service module, a corporate bill selling identification encryption module and a corporate bill selling interface module; and the front-end corporate bill self-service terminal comprises a terminal host, a corporate bill storage box, a corporate bill clearing box, an authentication module, a front-end interface, a corporate bill information print module and a corporate bill information scanning module. The system block diagram is shown in FIG. 1.

First, a corporate bill selling center platform and at least one front-end corporate bill self-service terminal are connected to form a corporate bill selling system with anti-counterfeiting verification. The corporate bill selling center platform is used for providing entry of system basic platform building information, data storage, equipment monitoring, optical character recognition (OCR), interface with an external system and system data inquiry statistics management; the front-end corporate bill self-service terminal is used for storing corporate bills, achieving interaction with users, and acquiring and identifying key information of corporate bills, the acquisition and identification of key information of corporate bills comprise corporate bill image acquisition, corporate bill authenticity identification and corporate bill element entry; and the corporate bills comprise checks and/or receipts and/or drafts.

The corporate bill selling center platform consists of a corporate bill selling management module, a corporate bill selling service module, a corporate bill selling identification encryption module, a corporate bill selling interface module and a database, the corporate bill selling management module is connected with the database, the corporate bill selling service module is connected with the database and the corporate bill selling interface module, and the corporate bill selling identification encryption module is connected to the corporate bill selling service module. The corporate bill selling management module is used for management of basic information of the overall system, system parameter setting and the front-end corporate bill self-service terminal, as well as real-time monitoring of running status of the front-end corporate bill self-service terminal, and business acceptance statistics; the corporate bill selling service module is used for realizing data interaction between the front-end corporate bill self-service terminal and the corporate bill selling center platform; the corporate bill selling identification encryption module is used for realizing encrypted storage of key elements (including two-dimensional codes and magnetic codes of corporate bills) of corporate bills using OCR technology and encryption algorithm; the corporate bill selling interface module is used for connecting the front-end corporate bill self-service terminal; and the database is used for storing all kinds of data information.

At the front-end corporate bill self-service terminal, the authentication module is connected with the terminal host, the corporate bill information print module is connected with the terminal host, the corporate bill information scanning module is connected with the terminal host, the corporate bill storage box is connected with the corporate bill clearing box, the corporate bill storage box and the corporate bill clearing box are connected with the terminal host respectively, and the terminal host is connected to a private banking network through the front-end interface, and then connected to the corporate bill selling interface module of the corporate bill selling center platform via the private network; the terminal host is used for control of all modules connected thereto and interacts with the corporate bill selling center platform through the front-end interface; the corporate bill storage box is used for storing corporate bills; the corporate bill clearing box is used for providing corporate bills for users; the corporate bill clearing box is also equipped with a security gate connected with the terminal host, and in selling corporate bills, the terminal host receives command from the corporate bill selling management module to open the security gate and provide corporate bills for customers; the customer authentication module is used for authentication of corporate bill buyers based on input of the corporate bill buyers; the corporate bill information print module is used for printing required corporate bill face information including text information, magnetic code information and two-dimensional code information. In the embodiment, the printing device used by the corporate bill information print module can simultaneously print text, magnetic code and two-dimensional code; and the corporate bill information scanning module is used for scanning front and back images and UV images of corporate bills.

1. A corporate bill selling system with anti-counterfeiting verification, characterized by comprising a corporate bill selling center platform and at least one front-end corporate bill self-service terminal, and the corporate bill selling center platform being connected with the at least one front-end corporate bill self-service terminal;
the corporate bill selling center platform being used for providing entry of system basic platform building information, data storage, equipment monitoring, optical character recognition (OCR), interface with an external system and system data inquiry statistics management; and
the front-end corporate bill self-service terminal being used for storing corporate bills, achieving interaction with users, and acquiring and identifying key information of corporate bills.

2. The corporate bill selling system with anti-counterfeiting verification of claim 1, characterized in that the acquisition and identification of key information of corporate bills comprises corporate bill image acquisition, corporate bill authenticity identification and corporate bill element entry.

3. The corporate bill selling system with anti-counterfeiting verification of claim 1, characterized in that the corporate bill selling center platform comprises a corporate bill selling management module, a corporate bill selling service module, a corporate bill selling identification encryption module, a corporate bill selling interface module and a database, the corporate bill selling management module is connected with the database, the corporate bill selling service module is connected with the database and the corporate bill selling interface module, and the corporate bill selling identification encryption module is connected to the corporate bill selling service module;
the corporate bill selling management module is used for management of basic information of the overall system, system parameter setting and the front-end corporate bill self-service terminal, as well as real-time monitoring of running status of the front-end corporate bill self-service terminal, and business acceptance statistics;
the corporate bill selling service module is used for realizing data interaction between the front-end corporate bill self-service terminal and the corporate bill selling center platform;
the corporate bill selling identification encryption module is used for realizing encrypted storage of key elements of corporate bills using OCR technology and an encryption algorithm;
the corporate bill selling interface module is used for connecting the front-end corporate bill self-service terminal; and
the database is used for storing all kinds of data information.

4. The corporate bill selling system with anti-counterfeiting verification of claim 3, characterized in that the key elements comprise two-dimensional codes and magnetic codes of corporate bills.

5. The corporate bill selling system with anti-counterfeiting verification of claim 1, characterized in that the front-end corporate bill self-service terminal comprises a terminal host, a corporate bill storage box, a corporate bill clearing box, an authentication module, a front-end interface, a corporate bill information print module and a corporate bill information scanning module, the authentication module is connected with the terminal host, the corporate bill information print module is connected with the terminal host, the corporate bill information scanning module is connected with the terminal host, the corporate bill storage box is connected with the corporate bill clearing box, the corporate bill storage box and the corporate bill clearing box are connected with the terminal host respectively, and the terminal host is connected to a private banking network through the front-end interface, and then connected to the corporate bill selling interface module of the corporate bill selling center platform via the private network;
the terminal host is used for control of all modules connected thereto and interacts with the corporate bill selling center platform through the front-end interface;
the corporate bill storage box is used for storing corporate bills;
the corporate bill clearing box is used for providing corporate bills for users;
the customer authentication module is used for authentication of corporate bill buyers based on input of the corporate bill buyers;
the corporate bill information print module is used for printing required corporate bill face information; and
the corporate bill information scanning module is used for scanning front and back images and UV images of corporate bills.

6. The corporate bill selling system with anti-counterfeiting verification of claim 5, characterized in that the corporate bill clearing box is also equipped with a security gate connected with the terminal host.

7. The corporate bill selling system with anti-counterfeiting verification of claim 5, characterized in that the required corporate bill face information comprises text information, magnetic code information and two-dimensional code information.

8. The corporate bill selling system with anti-counterfeiting verification of claim 7, characterized in that a printing device used by the corporate bill information print module can simultaneously print text, magnetic code and two-dimensional code.

9. The corporate bill selling system with anti-counterfeiting verification of claim 1, characterized in that the corporate bills comprise checks and/or receipts and/or drafts.
